(19) United States
(12) Patent Application Publication
(10) Pub. No.: US 2002/0161903 A1
(43) Pub. Date: Oct. 31, 2002

(54) System for secure access to information provided by a web application

(76) Inventor: Lawrence M. Besaw, Ft. Collins, CO (US)

Correspondence Address: HEWLETT-PACKARD COMPANY, Intellectual Property Administration, P.O. Box 272400, Fort Collins, CO, 80527-2400, US

(21) Appl. No.: 09/843,888

(22) Filed: Apr. 30, 2001

(51) Int. Cl. G06F 15/16; G06F 15/173

(52) U.S. Cl. 709/229; 709/224

(57) ABSTRACT

A system for secure access to information, e.g., images, data, etc., is utilized to provide additional security to users of a management portal.. The management portal may be configured to embed a common gateway interface (“CGI”) link in a web page, e.g., HTML, extensible mark-up language (“XML”), at the end the conclusion of the management transaction. Subsequently, the web page with the embedded CGI link may be transmitted to the user. To access the stored information, the user may invoke the CGI link on the received web page. The CGI link may be configured to invoke an application, a security module, at a web server of the management portal e.g., CGI script, web application, etc., that may request a user name and/or authorization code from the user. The security module may be further configured to compare the requested information against a user configuration database of the management portal, where the user configuration may be constructed in XML code. The security module may be further configured to permit access to the secure storage area, and subsequently to the information stored therein, in response to a match of the requested information with the user configuration database. Otherwise, the security module may be further configured to inform the user of denied access to the secure storage area.

### RELATED APPLICATIONS

The following commonly assigned applications, filed concurrently, may contain some common disclosure and may relate to the present invention are hereby incorporated by reference:

U.S. patent application Ser. No. 09/______, entitled “SYSTEM FOR DYNAMIC CUSTOMER FILTERING OF MANAGEMENT INFORMATION PRESENTED THROUGH A WEB-BASED PORTAL ” (Attorney Docket No. 10006612-1);

U.S. patent application Ser. No. 09/______, entitled “SYSTEM FOR DISPLAYING TOPOLOGY MAP INFORMATION THROUGH THE WEB” (Attorney Docket No. 10006654-1);

U.S. patent application Ser. No. 09/______, entitled “DYNAMIC GENERATION OF CONTEXT-SENSITVE DATA AND INSTRUCTIONS FOR TROUBLESHOOTING PROBLEM EVENTS AND INFORMATION NETWORK SYSTEMS” (Attorney Docket No. 10992465-1); and

U.S. patent application Ser. No. 09/______, entitled “A PORTAL SYSTEM AND METHOD FOR MANAGING RESOURCES IN A COMPUTING ENVIRONMENT” (Attorney Docket No. 10992434-1).

### FIELD OF THE INVENTION

This invention relates generally to information access, and more particularly to accessing information from a secure area utilizing an Internet application.

### DESCRIPTION OF THE RELATED ART

Network communications have become a fundamental part of today's computing. It is not uncommon to find two or more computer systems working together to resolve issues such as simulations, modeling, forecasting, etc. In fact, these efforts have been so successful, users have been inclined to design and implement larger and more powerful networks.

As the networks grow larger, increasingly complex, and interface with a variety of diverse networks, it is the task of a network manager (or administrator/user) to keep track of the devices on the networks, to monitor performances and load, to diagnose, and to correct problems with the network.

To assist a network manager, network management software (“NMS”) may be used in the management of a network. The conventional NMS is typically executed on a management device or node of the network. The conventional NMS may be configured to determine a network topology, detect malfunctioning remote network devices or communication links, monitor network traffic, etc., while executing on a management node of the network.

As part of the monitoring duties, the network manager may configure the NMS to conduct network management transactions such as displaying network topology maps. The network topology maps may be configured to display network nodes, links between network nodes, etc. Typically, the topology maps are created by a display module when a user invokes a display command within the NMS. The display module usually generates the requested topology maps by passing arguments and/or data to a graphics library, e.g., libgd.

Since some network topology maps are dynamically created during a session of a typical NMS, a requested network topology map may not be viewed by embedding an image of the network topology map into a hypertext mark-up language (“HTML”) page, an extensible mark-up language (“XML”) page, or the like, i.e., a web page. Instead, a network topology map is generated and stored at the management node providing the execution platform of the NMS. An address reference to the stored topology map is sent to the user by the NMS. A user typically accesses the management node and performs file operations to access the network topology map.

However, the technique of sending an address reference is not a preferred method of providing access to a network topology map. For example, an unauthorized user who has gained access to the management node may “guess” the location of a generated network topology map by typing in address references. Accordingly, the above-mentioned technique may not provide a method of secure access to potentially sensitive data e.g., network topology maps nor provide a secure area for storing.

One solution to provide security to users is to use a web server. The web server is typically configured to provide access to certain directories and files based on the user verification information, e.g., a user name, password, etc. However, this solution has some drawbacks. For example, a user may find using the web server inconvenient. The user initially logs into a management node to gain access to network services. To gain access to a generated network topology map through the web server, the user is required to type in his/her verification information again, which the user may find inconvenient. Moreover, since network topology maps are generated dynamically, a web server administrator cannot configure the web server beforehand to permit access to files that are not created and/or named yet.

### SUMMARY OF THE INVENTION

In accordance with the principles of the present invention, a method of secure access to information over a network includes storing information in a secure storage area in a remote network node and transmitting an application link in a web page. The method further includes initiating the application link to access to the secure storage area.

In accordance with another aspect of the principles of the present invention, a system for secure access to information over a network includes at least one processor, a memory coupled to said at least one processor and a management information portal residing in said memory and executed by said at least one processor. The management information portal is configured to store information in a secure storage area in a remote network node, transmit an application link in a web page, and initiate the application link to access to the secure storage area.

In accordance with another aspect of the principles of the present invention, a computer readable storage medium is embedded in one or more computer programs that implement a method of secure access to information over a network. The one or more computer programs include a set of instructions for storing information in a secure storage area in a remote network node and transmitting an application link in a web page. The one or more computer programs further include initiating the application link to access to the secure storage area.

### BRIEF DESCRIPTION OF THE DRAWINGS

FIG. 1 illustrates a system where an exemplary embodiment of the present invention may be practiced;

FIG. 2 illustrates a detailed block diagram of an exemplary embodiment of a management information portal according to the principles of the present invention;

FIG. 3 illustrates an exemplary computer system where an embodiment of the present invention may be practiced in accordance with the principles of the present invention;

FIG. 4 illustrates an exemplary flow diagram of the topology map module shown in FIG. 2 in accordance with the principles of the present invention; and

FIG. 5 illustrates an exemplary flow diagram of an interfacing between the security module and the topology map module shown in FIG. 2 in accordance with the principles of the present invention.

### DETAILED DESCRIPTION OF A PREFERRED EMBODIMENT

For simplicity and illustrative purposes, the principles of the present invention are described by referring mainly to an exemplary embodiment of a service provided by a management information portal. However, one of ordinary skill in the art would readily recognize that the same principles are equally applicable to all types of information access over a network, and can be implemented in any network and in any communication protocols, and that any such variation would be within such modifications that do not depart from the true spirit and scope of the present invention.

According to an embodiment of the present invention, a system for secure access to information, e.g., images, data, and other type of files stored on a computer system, is utilized to provide additional security to customers of a management portal. The management portal may be configured to provide network services (e.g., Internet service provider, electronic mail (“e-mail”), etc.) to a variety of customers. As part of the provided network services, the management portal may be further configured to provide network management services, e.g., monitoring, troubleshooting, etc., for the allocated network service of a customer. A customer may perform a management transaction (e.g., generating a network topology map, generating status reports, viewing selected performance attributes, etc.,) in the management portal where the resulting information (e.g., a text file, a data file, an image file, etc.,) from the management transaction may be stored in an allocated memory space. Each customer may be allocated memory space in a secure storage area of the management portal, where each customer may be authenticated prior to gaining access to the allocated memory space. Alternatively, a customer may be given access to information (e.g., images, data, files, etc.) on a file-by-file basis. The management portal may be configured to embed a web application link in a web page at the conclusion of the management transaction. The web application may be a common gateway interface (“CGI”), a JAVA servlet or any web application that runs on a server. The link to the web application may be a hypertext link, a uniform resource locator (“URL”) and the like. The web page may be a document generated by the management portal formatted according to HTML, extensible mark-up language (“XML”) and the like. Subsequently, the web page with the embedded web application link may be transmitted to the customer.

To access the stored information, the customer may invoke the web application link (e.g., a CGI link) by opening the received web page with a web browser. As the web browser parses the received web page, the web application link is activated by the parsing of an attribute (e.g., the SRC attribute of the IMG tag) of the received page. The web application link may be configured to invoke an application, a security module, at a web server of the management portal (e.g., CGI script, web application, etc.) that may request a customer name and/or authorization code from the customer if the customer has not already been authenticated. A topology map module may be configured to compare the requested information against data in a user configuration database of the management portal, where the user configuration database may be constructed in XML code. The topology map module may be further configured to permit access to the secure storage area, and subsequently to the information stored therein, in response to a match of the requested information with the customer configuration database. Otherwise, the topology map module may be further configured to inform the customer of denied access to the secure storage area. Accordingly, an unauthorized customer may be prevented access to information, and thus, increasing the security of information stored in the management portal.

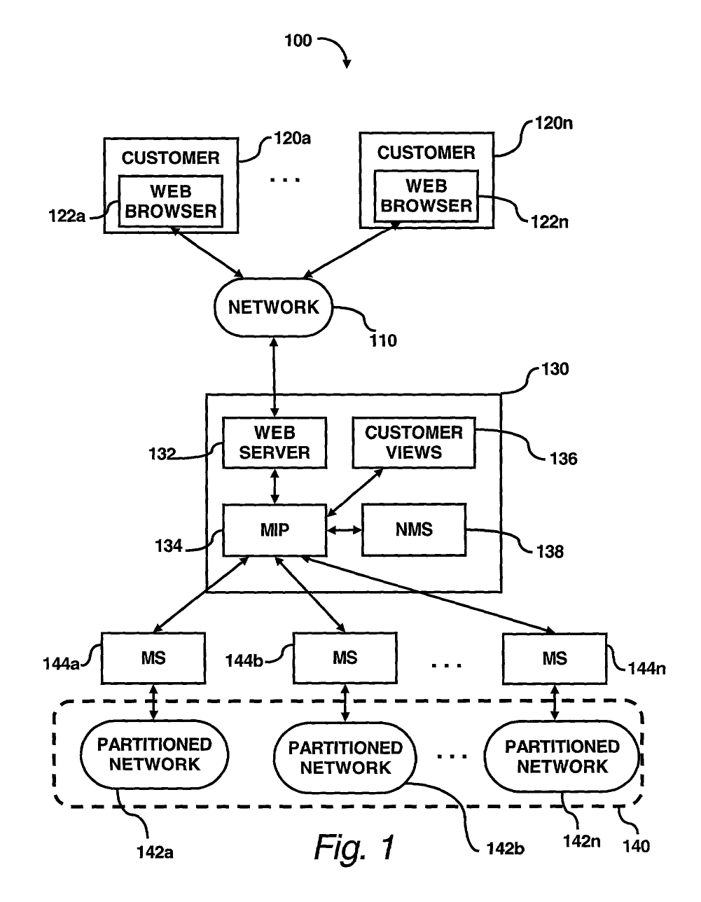

FIG. 1 illustrates a system 100 where an exemplary embodiment of the present invention may be practiced. As shown in FIG. 1, the system 100 includes at least one network 110 interfaced between customers 120 and a management portal 130. The network 110 may be may be implemented as a local area network, a wide area network, a wireless network, Internet or the like. Although, in the exemplary embodiment, the network 110 may utilize a hypertext transfer protocol (“HTTP”) to provide communication services between the customers 120 and the management portal 130, a variety of other network protocols (TCP/IP, X.25, etc.,) may also be used to provide communication services.

Although, for illustrative purposes, only one network 110 is shown in FIG. 1, it should be understood and readily apparent to those familiar with networks that there may be any number of networks interfacing customers 120 and the management portal 130.

A service provider may offer a variety of network services to customers 120. The customer may be a management information system group, a network administrator, a corporation, an organization, etc. The network services may include Internet services, electronic mail (e-mail) services, network management service and the like. A customer may not prefer to create and/or manage a network to provide network services, which may be driven by a lack of expertise, cost, etc. The customer may utilize the service provider to receive the desired network services. The service provider would then configure a portion of its own network 140 into partitioned networks 142, and each partitioned network may be allocated to a customer.

The service provider may configure the management portal 130 to provide management services to the customers 120. As one of the services, the service provider may configure the management portal 130 to provide the capability for a customer to conduct network management transactions such as viewing relevant information of the customer's partitioned network in a topology map, generating status reports, and the like, where the resulting information may be stored in a secure area allocated to the customer. A web page may be generated with a CGI link (or URL) and then sent to the customer. The CGI link may be configured to determine whether the customer has access to the secure area. The customer may invoke the CGI link to view information in the secure area. A security module may be configured to request that the customer input verification information, e.g., a customer identification, a password, etc. The security module may be further configured to compare the verification information with a user configuration database. If the verification is valid, the security module may be configured to permit access to the customer. Otherwise, if the verification is invalid, the security module may be further configured to deny access to the customer.

For example, to request and view a topological map, a customer 120a may invoke a web browser 122a, e.g., the NAVIGATOR from the Netscape Communications Corporation of Mountain View, Calif., USA, or the INTERNET EXPLORER from the Microsoft Corporation of Redmond, Wash., USA. The web browser 122a of the customer 120a may contact a web server 132 of the management portal 130. The web server 132 may be at least configured to provide authentication services for the customer 120a to provide security services for the customers 120.

Once authenticated, a customer 120a may be given access to the management information portal 134 of the management portal 130. The management information portal 134 may be configured to provide customized management services to the customers 120 by referencing a customer views module 136. The customer views module 136 may be configured to maintain a database of the types of services available to each customer in response to being authenticated by the management portal 130.

The management information portal 134 may be further configured to interface with a network management software (“NMS”) 138. The NMS 138 may be configured to provide network management services such as monitoring, diagnosis, and the like, to the management information portal 134 for the network 140.

The management information portal 134 may be further configured to interface with management stations 144. The management stations 144 may be configured to provide a management node function for each of the partitioned networks 142.

In one aspect of the present invention, the management information portal 134 may be configured to provide a network management transaction of generating topology network maps for a customer. Once the topology map is generated, a web page with a web application link, e.g., a CGI URL, to the security module may be generated and transmitted to the customer. To view the generated topology map, the customer may display the transmitted web page on the customer's web browser. As the web page is being parsed by the customer's web browser, an attribute (e.g., the SRC attribute of the IMG tag) of the web application link is activated and may invoke the security module. The security module may request verification information if the customer has not logged into the management information portal 134. The security module may be configured to pass control over to a topology map module. The topology map module may be configured to the verification information against information in a user configuration database of the management information portal 134. If verified, the topology map module may permit access to the customer. Otherwise, the topology map module may deny access to the customer.

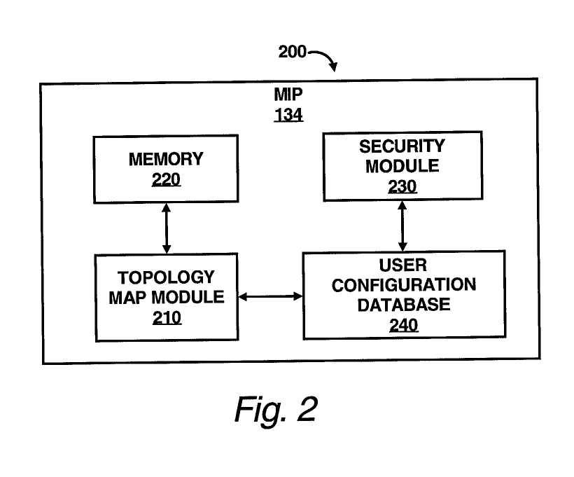

FIG. 2 illustrates a more detailed block diagram 200 of an exemplary embodiment of a management information portal according to the present invention. In particular, the management information portal 134 may be at least configured to interface with a topology map module 210. The topology map module 210 may be configured to provide customers with requested topology maps as a management transaction of the network services. For example, when a customer (or user) requests a topology map, the topology map module 210 may be configured to generate the requested topology map based on customer requested data. The topology map module 210 may be further configured to generate a web page with a CGI URL to provide access to the stored topology map.

FIG. 2 illustrates the topology map module 210 providing a management transaction for illustrative purposes only, it is thus not be construed to be limiting to the present invention in any respect. Instead, it should be readily apparent to those skilled in the art that other types of modules such as a network heath module, an alarm module, and the like may be utilized without deviating from the scope or spirit of the present invention.

As illustrated in FIG. 2, the topology map module 210 may be configured to interface with a memory 220. The memory 220 may be configured to provide a memory space for the storage of information from management transactions such as topology maps from the topology map module 210, where each customer of the management portal 130 may be allocated memory space. The memory 220 may be implemented with dynamic random access memory, a hard disk, or any addressable memory device.

The topology map module 210 may be further configured to interface with a security module 230 through a user configuration database 240. The security module 230 may be configured to provide security services to the memory 220. When invoked by a customer through activation by a web application link, e.g., CGI URL, the security module 230 may be configured to verify if the customer has logged into the management information portal 134. If verified, the security module 230 may be further configured to permit the customer access to the customer's allocated memory space. Otherwise, the security module 230 may be further configured to deny access to the customer.

The user configuration database 240 of the management information portal 134 may be configured to provide a database of the configuration parameters of each customer of the management portal 130. A customer may be provided with customized network services from the settings of the configuration parameters. A subset of the configuration parameters may be configured to determine access to a customer's allocated memory space in the memory 220.

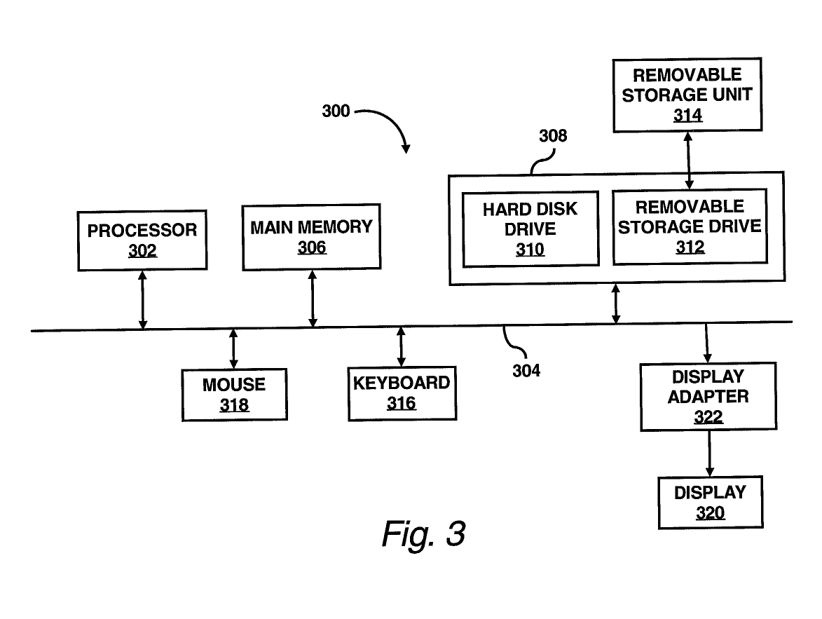

FIG. 3 illustrates an exemplary computer system 300 where an embodiment of the present invention may be practiced in accordance with the principles of the present invention. The functions of the management information portal 134 are implemented in program code and executed by the computer system 300. In particular, the computer system 300 includes one or more processors, such as a processor 302 that provides an execution platform for the management information portal 134. Commands and data from the processor 302 are communicated over a communication bus 304. The computer system 300 also includes a main memory 306, preferably Random Access Memory (RAM), where the software for the management information portal 134 is executed during runtime, and a secondary memory 308. The secondary memory 308 includes, for example, a hard disk drive 310 and/or a removable storage drive 312, representing a floppy diskette drive, a magnetic tape drive, a compact disk drive, etc., where a copy of software for the management information portal 134 may be stored. The removable storage drive 312 reads from and/or writes to a removable storage unit 314 in a manner known to those of ordinary skill in the art. A customer from the service provider may interface directly with the management information portal 134 with a keyboard 316, a mouse 318, and a display 320. A display adaptor 322 interfaces with the communication bus 304 to receive display data from the processor 302 and converts the display data into display commands for the display 320.

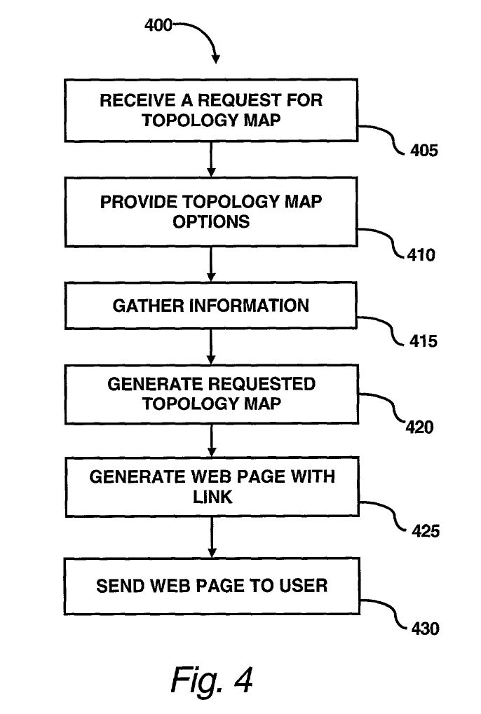

FIG. 4 illustrates an exemplary flow diagram 400 of the topology map module 210 in accordance with the principles of the present invention. In particular, in step 405, the topology map module 210 may be configured to receive a request to generate a topology map from a customer 120, as described herein above. The topology map module 210 may be further configured to display a list of topology map options for the requested topology map, in step 410. The topology map options may include a list of parameters such as performance attributes, status, throughput and the like. By enabling one or more of the topology map options, a filtering process may be applied to reduce the amount of information presented to the customer, thereby creating a customized topology map for the customer.

In step 415, the topology map module 210 may be configured to gather the appropriate information as filtered by the topology map options. The topology map module 210 may be further configured to generate the requested topology map, in step 420. The requested topology map may be stored in a memory location allocated by the management portal 130 in a graphics format selected by the customer.

In step 425, the topology map module 210 may be further configured to generate a web page with a web application link (a CGI URL, A hypertext reference, etc.,) of the stored topology map. The web page is then forwarded over the network 110 (as shown in FIG. 1) to the customer of the network node 220, in step 430.

Accordingly, a customer may access the requested topology map by viewing the forwarded web page on the customer's web browser. As the web browser is parsing the web page, the web browser may parse an attribute (e.g., the SRC attribute of the IMG tag) in the web application link which automatically invokes the security module to verify and display the stored topology map.

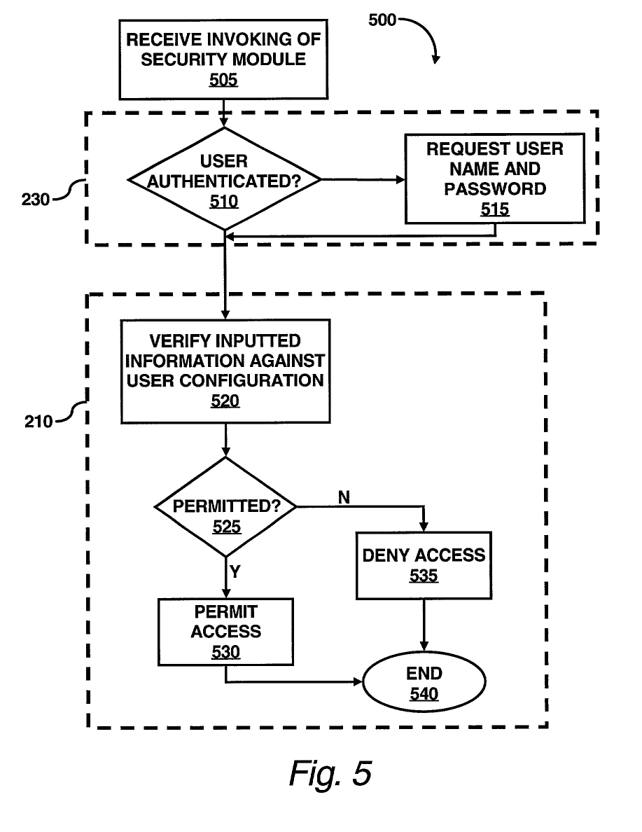

FIG. 5 illustrates an exemplary flow diagram of the security module shown in FIG. 2 interfacing with the topology map module 210 shown in accordance with the principles of the present invention. In particular, the security module 230 may be invoked by the activation of the transmitted web page by a customer opening the web page with a web browser, in step 505. The security module 230 may be further configured to determine whether the customer has been authenticated or logged into the management information portal 134, in step 510. If the customer has not logged into the management information portal 134, the security module 230 may be further configured to request that the customer input verification information, in step 515. Otherwise, if the customer has logged into the management information portal 134, the security module 130 is configured to pass control onto the topology map module 210.

In step 520, the topology map module 210 may be further configured to compare the inputted verification information from either the initial log-in into the management portal 134 or the security module 230 against the information stored in the user configuration database 240. If, in step 525, the inputted verification information is verified, the topology map module 210 may be further configured to permit access to the information in the customer's allocated memory space in the memory 220, in step 530. Otherwise, the security module 230 may be further configured to deny access, in step 535, to the customer's allocated memory space in the memory 220. The topology map module 210 may be configured to end, in step 540.

The present invention may be performed as a computer program. The computer program may exist in a variety of forms both active and inactive. For example, the computer program can exist as software program(s) comprised of program instructions in source code, object code, executable code or other formats; firmware program(s); or hardware description language (HDL) files. Any of the above can be embodied on a computer readable medium, which include storage devices and signals, in compressed or uncompressed form. Exemplary computer readable storage devices include conventional computer system RAM (random access memory), ROM (read-only memory), EPROM (erasable, programmable ROM), EEPROM (electrically erasable, programmable ROM), and magnetic or optical disks or tapes. Exemplary computer readable signals, whether modulated using a carrier or not, are signals that a computer system hosting or running the present invention can be configured to access, including signals downloaded through the Internet or other networks. Concrete examples of the foregoing include distribution of executable software program(s) of the computer program on a CD ROM or via Internet download. In a sense, the Internet itself, as an abstract entity, is a computer readable medium. The same is true of computer networks in general.

While the invention has been described with reference to the exemplary embodiments thereof, those skilled in the art will be able to make various modifications to the described embodiments of the invention without departing from the true spirit and scope of the invention. The terms and descriptions used herein are set forth by way of illustration only and are not meant as limitations. In particular, although the method of the present invention has been described by examples, the steps of the method may be performed in a different order than illustrated or simultaneously. Those skilled in the art will recognize that these and other variations are possible within the spirit and scope of the invention as defined in the following claims and their equivalents.

What is claimed is:

1. A method of securely accessing information over a network, comprising:
storing information in a secure storage area in a remote network node;
transmitting an application link in a web page; and
receiving an initiation of said application link to access to said secure storage area.

2. The method of securely accessing information over a network according to claim 1, further comprising:
invoking an application on said remote network node in response to said initiation of said application link, wherein said application is configured to determine access to said secure storage area.

3. The method of securely accessing information over a network according to claim 2, further comprising:
accessing a user configuration database to determine access to said secure storage area.

4. The method of securely accessing information over a network according to claim 3, further comprising:
transmitting said information over said network to a requestor in response to said user configuration database permitting access to said secure storage area.

5. The method of securely accessing information over a network according to claim 4, wherein said information is transmitted according to a hypertext transfer protocol.

6. The method of securely accessing information over a network according to claim 4, wherein said application link includes a common gateway interface program link.

7. The method of securely accessing information over a network according to claim 4, wherein said user configuration database is constructed using a extensible mark-up language.

8. A system for securely accessing information over a network, said system comprising:
at least one processor;
a memory coupled to said at least one processor;
a management information portal residing in said memory and executed by said at least one processor, wherein said management information portal is configured to store information in a secure storage area in a remote network node, transmit an application link in a web page, and receive an initiation of said application link to access to said secure storage area.

9. The system for securely accessing information over a network according to claim 8, wherein said management information portal is configured to determine access to said secure storage area in response to an invocation of an application on said remote network node.

10. The system for securely accessing information over a network according to claim 8, wherein said management information portal is further configured to access a user configuration database to determine access to said secure storage area.

11. The system for securely accessing information over a network according to claim 10, wherein said management information portal is further configured to transmit said information over said network to a requestor in response to said user configuration database permits access to said secure storage area.

12. The system for securely accessing information over a network according to claim 11, wherein said information is transmitted according to a hypertext transfer protocol.

13. The system for securely accessing information over a network according to claim 11, wherein said application link includes a common gateway interface program.

14. A computer readable storage medium on which is embedded one or more computer programs, said one or more computer programs implementing a method for securely accessing information over a network, said one or more computer programs comprising a set of instructions for:
storing information in a secure storage area in a remote network node;
transmitting an application link in a web page; and
receiving an initiation of said application link to access to said secure storage area.

15. The computer readable storage medium according to claim 14, said one or more computer programs further comprising a set of instructions for:
invoking an application on said remote network node in response to said initiation of said application link, wherein said application is configured to determine access to said secure storage area.

16. The computer readable storage medium according to claim 15, said one or more computer programs further comprising a set of instructions for:
accessing a user configuration database to determine access to said secure storage area.

17. The computer readable storage medium according to claim 16, said one or more computer programs further comprising a set of instructions for:
transmitting said information over said network to a requester in response to said user configuration database permits access to said secure storage area.

18. The computer readable storage medium according to claim 17, said one or more computer programs further comprising a set of instructions, wherein said information is transmitted according to a hypertext transfer protocol.

19. The computer readable storage medium according to claim 17, said one or more computer programs further comprising a set of instructions, wherein said application link includes a common gateway interface program link
